(19) United States
(12) Patent Application Publication
(10) Pub. No.: US 2024/0136954 A1
(43) Pub. Date: Apr. 25, 2024

(54) COGENERATION APPARATUS, THERMOELECTRIC POWER GENERATION SYSTEM, VOLTAGE CONTROL METHOD AND HEATING DEVICE

(71) Applicant: Zhejiang Saipu Energy Co., Ltd., Hangzhou (CN)

(72) Inventors: BEIBEI HU, Zhuhai (CN); YUANJUN TANG, Hangzhou (CN)

(21) Appl. No.: 18/225,901

(22) Filed: Jul. 24, 2023

(30) Foreign Application Priority Data
Oct. 21, 2022 (CN) 202211297598.6

(51) Int. Cl. H02N 11/00; F24F 1/0097

(52) U.S. Cl. CPC H02N 11/002; F24F 1/0097

(57) ABSTRACT

The present disclosure belongs to technical field of thermoelectricity, particularly relates to a cogeneration apparatus, including a thermal collector and a thermoelectric power generation component, the thermoelectric power generation component is disposed on the thermal collector and an end face at one side contacts with the thermal collector, the cogeneration apparatus can collect the heat generated after gas combustion through the thermal collector, the heat is used for heating one end of the thermoelectric power generation component, so that two ends of the thermoelectric power generation component form a temperature difference, thereby realizing power generation. In this solution, a compensating distance is disposed between an upper end of the thermoelectric power generation component and an upper end of the thermal collector. The whole power generation efficiency of the apparatus is improved through a relationship between the output power of the thermoelectric power generation component and the compensating distance.

### CROSS-REFERENCE TO RELATED APPLICATIONS

This is a U.S. patent application which claims the priority and benefit of Chinese Patent Application Number 202211297598.6, filed on Oct. 22, 2022, the disclosure of which is incorporated herein by reference in its entirety.

### TECHNICAL FIELD

The present disclosure belongs to the technical field of thermoelectricity, in particular relates to a cogeneration apparatus, a thermoelectric power generation system, and a voltage control method for a thermoelectric power generation wind turbine.

### BACKGROUND

With the development of the technology, the thermoelectric power generation technology is more and more widely used, for example, it is used on a generator or outdoor power generation. However, the existing thermoelectric power generation device adopts combustion gas to heat one end of a thermoelectric generation sheet. For example, the other end of the thermoelectric generation sheet of the biomass fuel thermoelectric generator in the prior art only adopts a heat radiation structure, making the two ends of the thermoelectric generation sheet form a temperature difference, and the heat radiation structure adopts a heat radiation plate and a fin structure. The speed of the heat radiation in this manner is affected by an environment temperature, and the environment temperature also rises in an environment that a heat source is provided based on combustion, causing the temperature difference at the two ends of the thermoelectric generation sheet to reduce, thereby affecting the power generation effect.

In addition, a fuel source of a portable combustion device in the prior art is placed in a combustion chamber for combustion, a sealed TEG (Thermoelectric Generator) shell is installed at a side of the combustion chamber, and TEG generates electrical output based on the temperature difference at the two opposite sides. A heat-conducting probe and a heat-conducting probe base unit are installed on the TEG shell, and protrude into the combustion chamber through a small channel. In this solution, the problem of low power generation efficiency still exists due to great heat loss.

Moreover, in the prior art, a combustion power generation furnace and a power generation and charging method thereof, including a furnace body, a gas port, a fuel inlet, an opening and a thermoelectric converter, where the gas port is disposed on the furnace body for circulating gas, the fuel inlet is disposed on the furnace body, and the opening is disposed on the furnace body for installing the thermoelectric converter, the thermoelectric converter includes a heat conductor connected to a thermal end of the thermoelectric converter, and a heat sink connected to a cold end of the thermoelectric converter, and the heat conductor is located in the furnace body, and the heat sink is located outside the furnace body. With regard to the technical problem of low biomass power generation efficiency, this solution may improve the power generation efficiency. But in an actual structure, there are sill many factors affecting the power generation efficiency. How to improve the power generation efficiency and stability through a reasonable structure design is a technological difficulty of the thermoelectric power generation device.

### SUMMARY

The purpose of the present disclosure is to provide a cogeneration apparatus. Through reasonable structure setting, heat provided by the cogeneration apparatus after gas combustion makes a thermoelectric power generation component perform power generation.

In view of this, the present disclosure provides a cogeneration apparatus, including:
a thermal collector;
a thermoelectric power generation component, which is disposed on the thermal collector, and an end face at one side of the thermoelectric power generation component contacts with the thermal collector, and
an upper end face of the thermal collector is higher than that of the thermoelectric power generation component, a compensating distance exists between the upper end face of the thermoelectric power generation component and the upper end face of the thermal collector.

According to the cogeneration apparatus described above, the thermoelectric power generation component at least includes a plurality of first thermoelectric power generation sheets disposed on one side of the thermal collector, and the height of the thermal collector meets: H=h+X±20 mm; and
h is the total height after the plurality of first thermoelectric power generation sheets are arranged, and X is the height of a single first thermoelectric power generation sheet.

According to the cogeneration apparatus described above, a thermal collecting chamber is disposed in the thermal collector, and a plurality of thermal collecting members located in the thermal collecting chamber are also disposed on the thermal collector.

According to the cogeneration apparatus described above, the compensating distance ranges from 12 mm to 55 mm.

According to the cogeneration apparatus described above, the compensating distance is 42 mm.

According to the cogeneration apparatus described above, further including a cold-end component, which contacts with the end face of the other side of the thermoelectric power generation component, and end faces of the two sides of the thermoelectric power generation component form a temperature difference through a cold source.

According to the cogeneration apparatus described above, further including a heat exchanger, which is disposed at an upper end of the thermal collector, an exhaust port is disposed on the heat exchanger, and a wind turbine component is also disposed in the heat exchanger.

According to the cogeneration apparatus described above, further including a combustion chamber, the thermal collector includes a left shell and a right shell that are mutually and detachably connected, the left shell and the right shell are mutually installed to form the thermal collecting chamber, and the combustion chamber is disposed at a lower side of the thermal collector and communicates with the thermal collecting chamber; and
each thermal collecting member includes a plurality of first rib columns and a plurality of second rib columns, the plurality of first rib columns are disposed in the left shell, and the plurality of second rib columns are disposed in the right shell.

According to the cogeneration apparatus described above, two sides of the thermal collector are also equipped with raised installation portions, in which temperature boreholes are drilled, and temperature sensors are disposed on the temperature boreholes.

According to the cogeneration apparatus described above, further including a first splint and a second splint, which are connected to the thermal collector through connecting rods.

The present disclosure further provides a thermoelectric power generation system, including the cogeneration apparatus described above as well as a control system, a power storage apparatus, a second heat exchanger and a water supply system;
the control system is electrically connected to the cogeneration apparatus;
the power storage apparatus is configured to store electric energy generated by the cogeneration apparatus and to perform power supply or auxiliary power supply on an electrical appliance, and the power storage apparatus is equipped with an output port, and is electrically connected to the cogeneration apparatus, the control system, the second heat exchanger and the water supply system;
the second heat exchanger is connected to the heat exchanger, and
the water supply system is connected to the second heat exchanger, so as to provide the cold-end component with a cold source.

The present disclosure further provides a voltage control method for a thermoelectric power generation wind turbine, including the following steps of:
step 1: controlling a voltage value of a wind turbine component to an intimal voltage value U0 and obtaining the current generated power P0 after starting a cogeneration apparatus;
step 2: controlling the voltage value of the wind turbine component to a first voltage U1, and obtaining first generated power P1, where U1=U0+UP, and UP is a unit voltage value;
step 3: controlling the voltage value of the wind turbine component to a second voltage U2 and obtaining second generated power P2, where U1=U0-Up;
step 4: comparing the current generated power P0 with the first generated power P1 and the second generated power P2;
step 5:
the cogeneration apparatus keeping the current voltage value for working until the control being end if the current generated power P0 being a maximum value;
if the first generated power P1 being a maximum value in the current generated power P0 and the second generated power P2, adjusting the current generated power P0 to P1, and repeating steps 2-5 until the control being end; and
if the second generated power P2 being a maximum value in the current generated power P0 and the first generated power P1, adjusting the current generated power P0 to P2, and repeating steps 2-5 until the control being end.

The present disclosure further provides a heating device, including the thermal collector, on which a heat collecting member is disposed, and a warm air exporting component is also connected to an outer side of the thermal collector.

After implementing the embodiments of the present disclosure, the present disclosure has the following beneficial effects:

The present disclosure provides the cogeneration apparatus, which can collect the heat generated after gas combustion through the thermal collector, the heat is used for heating one end of the thermoelectric power generation component, so that the two ends of the thermoelectric power generation component form the temperature difference, so as to realize power generation. In this solution, the compensating distance is disposed between the upper end of the thermoelectric power generation component and the upper end of the thermal collector, and the whole power generation efficiency of the apparatus is improved through a relationship between the output power of the thermoelectric power generation component and the compensating distance.

### BRIEF DESCRIPTION OF DRAWINGS

To better clarify the technical solution of the embodiments of this application, the accompanying drawings required to illustrate the embodiments will be simply described below. Obviously, the accompanying drawings described below merely illustrate some embodiments of this application. Those ordinarily skilled in the art can obtain other drawings without contributing creative labor on the basis of those drawings.

FIG. 1 is a structural schematic diagram of a cogeneration apparatus of the present disclosure.

FIG. 2 is an exploded view I of FIG. 1.

FIG. 3 is a relationship diagram of a compensating distance and output power.

FIG. 4 is a schematic diagram of a thermoelectric power generation system of the present disclosure.

### DETAILED DESCRIPTION

The technical solution in the embodiments of the present disclosure is clearly and completely elaborated below in combination with the drawings in the embodiments of the present disclosure. It is apparent that the described embodiments are only a part of the embodiments of the present disclosure but not all. Based on the embodiments of the present disclosure, all the other embodiments obtained by those of ordinary skill in the art on the premise of not contributing creative effort should belong to the protection scope of the present disclosure.

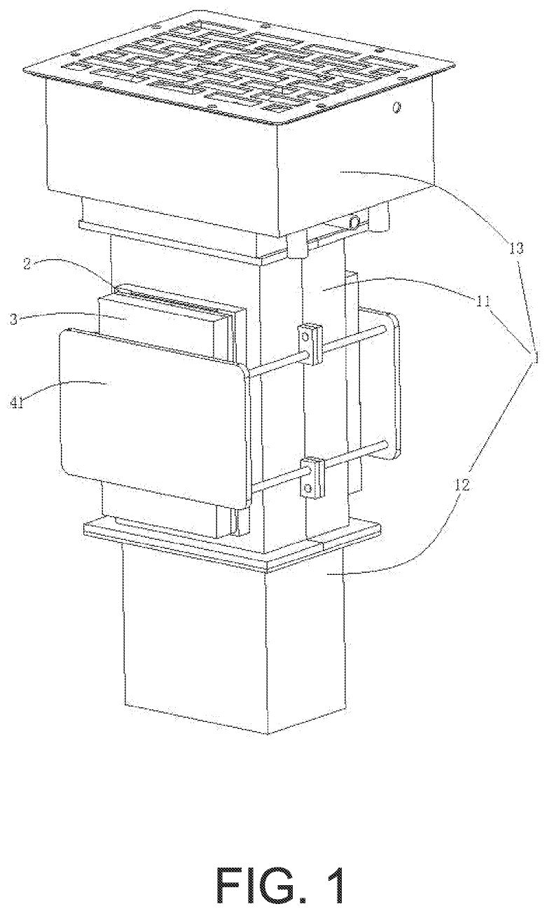

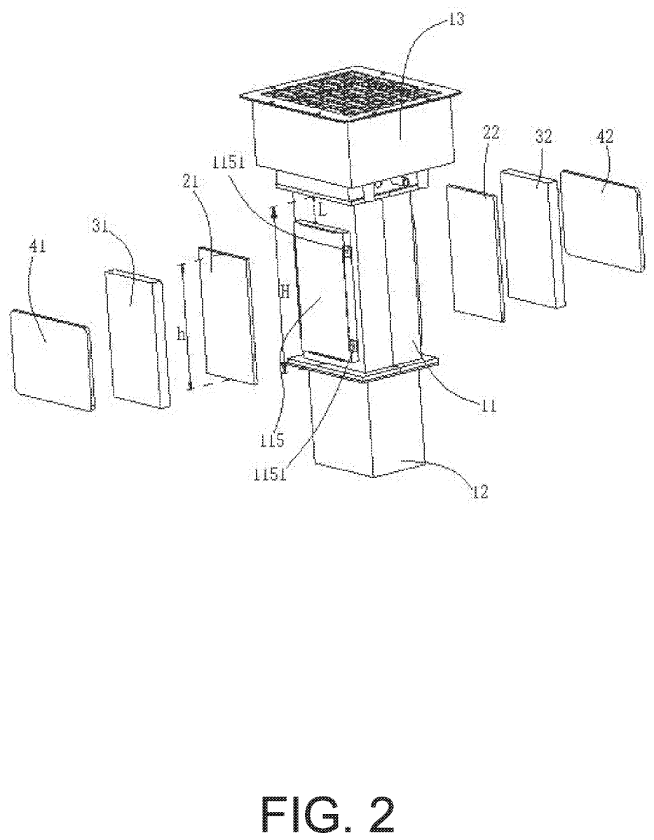

As shown in FIGS. 1 to 4, one embodiment of the present disclosure provides a cogeneration apparatus, including a thermal collector 11, which is configured to input gas combustion and to provide heat; a thermoelectric power generation component 2, which is disposed on the thermal collector 11 and an end face of one side contacts with the thermal collector 11 so as to output current; and a cold-end component 3, which contacts with the end face of the other side of the thermoelectric power generation component 2, so end faces of the two sides of the thermoelectric power generation component 2 form a temperature difference through a cold source. The present disclosure provides a cogeneration apparatus, which can collect the heat generated after gas combustion through the thermal collector, the heat is used for heating one end of the thermoelectric power generation component, so that the two ends of the thermoelectric power generation component form the temperature difference, so as to realize power generation. In this solution, a compensating distance is disposed between an upper end of the thermoelectric power generation component and an upper end of the thermal collector, and the whole power generation efficiency of the apparatus is improved through a relationship between the output power of the thermoelectric power generation component and the compensating distance.

Further, in one embodiment of the present disclosure, the cogeneration apparatus further includes the cold-end component 3, which contacts with the end face of the other side of the thermoelectric power generation component 2, and the end faces of the two sides of the thermoelectric power generation component 2 form the temperature difference through the cold source. The temperature difference at the two ends of the thermoelectric power generation component is improved in a manner that one end of the thermoelectric power generation component is absorbed by the thermal collector 11 while the other end is absorbed by the cold-end component, so as to improve the temperature difference at the two ends of the thermoelectric power generation component. Through reasonable structure setting, this solution enables the cogeneration apparatus to provide power output after gas combustion.

The cold source in this solution can cool one end of the thermoelectric power generation component 2 directly through water-cooling, air-cooling and the like. A system type, such as a water-cooling circulation system, may be adopted for cooling. Compared with the existing manner adopting the heat radiation structure, the system type has a more stable low temperature source so that a higher stable difference is formed at the two ends of the thermoelectric power generation component 2, thereby improving the power supply stability.

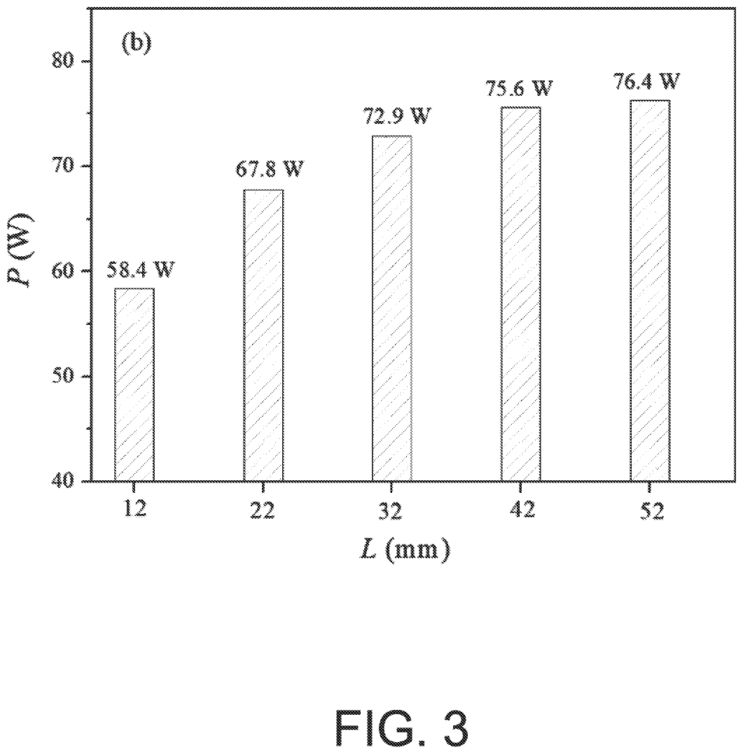

In the present disclosure, the compensating distance L ranges from 12 mm to 55 mm. Since the power generation performance of the thermoelectric power generation component 2 is related to the temperature difference at its two ends, as shown in FIG. 3, it can be known from the experiment that the generating capacity is greater when increasing the compensating distance, this is because the lower end of the thermal collector is closed to the heat source, the temperature inevitably declines when closer to the upper end, therefore the temperature closer to this side is lower and unstable, and if the thermoelectric power generation sheets are closed to the upper end, uneven heat is caused, and the power generation efficiency is not high. It can be known from the experiment data that the increase is smaller and smaller with the increased L. Therefore, L=42 mm is regarded as the optimized compensating distance.

The slope of the thermal end temperature becomes smaller when the compensating distance increases. For example, when L=12 mm, the thermal end temperature drops to 465 K from 521 K, and when L=42 mm, the thermal end temperature drops to 498 K from 520 K. Therefore, with the increase of the compensating length, the uniformity of the thermal end temperature is improved, which is conductive to releasing the potential of the thermoelectric power generation component 2.

Therefore, the present disclosure enables the thermoelectric power generation component 2 to obtain more uniform heat at the thermal end through a reasonable compensating distance design, and the structure is optimized so as to obtain higher power generation efficiency.

In the present disclosure, the thermoelectric power generation component 2 includes a plurality of first thermoelectric power generation sheets 21 and a plurality of second thermoelectric power generation sheets 22 that are disposed at two end faces of the thermal collector 11, and the cold-end component 3 includes first cold-end members 31 disposed on end faces of the first thermoelectric power generation sheets 21 and second cold-end members 32 disposed on end faces of the second thermoelectric power generation sheets 22. The efficiency is greatly improved through the power generation at the two sides.

In addition, in the present disclosure, when the plurality of first thermoelectric power generation sheets 21 are arranged in a rectangular array, the height H of the thermal collector 11 meets: H=a+1X±20, where a is the line number of the rectangular array, and X is the height of a single first thermoelectric power generation sheet 21. According to the analysis on the above compensating distance L, the compensating distance between the first thermoelectric power generation sheets 21 and the upper end of the thermal collector 11 is an important factor for affecting the power generation efficiency of the first thermoelectric power generation sheets 21, however the cogeneration apparatus adopts the structure of multiple thermoelectric power generation sheets, so the position for setting the thermoelectric power generation sheets on the thermal collector 11 and considering the parameter of the compensating distance will cause an oversize of the thermal collector 11 itself. This solution proposes a reasonable size parameter formula, in addition, considering that the total height of the thermoelectric power generation sheets in different arrangement methods is different, so the height H of the thermal collector 11 meets: H=h+X±20, where h is the total height of the plurality of first thermoelectric power generation sheets 21, and X is the height of a single first thermoelectric power generation sheet 21.

In the present disclosure, the cogeneration apparatus further includes a heat exchanger 13, which is disposed at an upper end of the thermal collector 11, an exhaust port is disposed on the heat exchanger 13, and a wind turbine component is also disposed in the heat exchanger 13. The combustion gas is discharged through the thermal collector 11 and the heat exchanger 13, and at the same time after the thermal collector 11 absorbs the heat of the combustion gas, the heat is delivered to the thermoelectric power generation component 2.

Moreover, after the combustion gas is discharged by the heat exchanger 3, the waste heat can also be collected through an external heat exchanger and other components, and the waste heat can be used for warm supply, heat supply, power generation and other purposes. The heat of the combustion gas is further used, so the heat utilization is maximized, at the same time the environment temperature of the wind turbine is reduced, and the wind turbine is ensured to work when conforming to the working temperature, its working reliability is improved, and the whole device structure is more compact.

In one embodiment of the present disclosure, in order to further improve the heat that is delivered to the thermoelectric power generation component 2 from the thermal collector 11, a thermal collecting chamber is disposed in the thermal collector 11, and a plurality of thermal collecting members located in the thermal collecting chamber are also disposed on the thermal collector 11. In this solution, the heat in the heat collecting chamber is absorbed and delivered to the thermoelectric power generation component 2 through the thermal collecting members.

In addition, in the above compensating distance L, the upper end face of the thermal collector 11 refers to the thermal collecting member that is located uppermost in the thermal collector 11, that is, the compensating distance L is the distance from the upper end of the uppermost thermal collecting member to the upper end of the uppermost thermoelectric power generation component 2.

Specifically, the cogeneration apparatus further includes a combustion chamber 12, the thermal collector 11 includes a left shell 111 and a right shell 112 that are mutually and detachably connected, the left shell 111 and the right shell 112 are mutually installed to form the thermal collecting chamber, and the combustion chamber 12 is disposed at a lower side of the thermal collector 11 and communicates with the thermal collecting chamber. However, each thermal collecting member includes a plurality of first rib columns and a plurality of second rib columns, the plurality of first rib columns are disposed in the left shell 111, and the plurality of second rib columns are disposed in the right shell 112. The combustion gas is discharged from the upper side through the thermal collecting chamber, in order to effectively use the gas heat, the heat is absorbed to the surfaces of the left shell 11l and the right shell 113 through the first rib columns and the second rib columns, so as to deliver the heat to the thermoelectric power generation component 2.

In the present disclosure, each rib column may be any one of round, square, triangle or polygon, and may also be sheet, and the main purpose is to increase the contact area between the rib columns and the combustion gas, thereby improving the heat absorption.

In the present disclosure, there are two methods to setting the first rib columns and the second rib columns. The first method is that the first rib columns and the second rib columns are set relatively one by one. The second method is that the first rib columns and the second rib columns are misplaced relatively. In addition, in this solution, the plurality of first rib columns also form a multi-layer arrangement, a layer-by-layer sequence arrangement may be adopted, or a displaced arrangement method of the two adjacent layers may also be adopted, in order to improve the heat absorption and improve the heat utilization rate.

In one embodiment of the present disclosure, in order to improve the heat absorption and collection of the thermal collector, the thermal collector is integrally made of a high heat conduction material, such as copper, aluminum, graphite.

In addition, in one embodiment of the present disclosure, both of the first cold-end member 31 and the second cold-end member 32 are water heat exchangers. Similarly, the output hot water may also be used as heat output, in order to improve the function of the apparatus.

Further, in one embodiment of the present disclosure, two sides of the thermal collector 11 are also equipped with raised installation portions 115, in which temperature boreholes 1151 are drilled. Temperature sensors are disposed on the temperature boreholes 1151, and the temperature sensors are configured to measure the temperature at the thermal end of the thermoelectric power generation component 2, which is helpful for preventing an excess temperature at the thermal end of the thermoelectric power generation component 2. In this solution, when detecting that the temperature at the thermal end of the thermoelectric power generation component 2 is higher than the maximum working temperature of the thermoelectric power generation component 2, the system enables the cogeneration apparatus to shut down or increases the voltage of the upper-end wind turbine component, thereby achieving the effect of protecting the thermoelectric power generation component 2.

Moreover, in the present disclosure, the cogeneration apparatus further includes a first splint 41 and a second splint 42, which are connected to the thermal collector 11 through connecting rods (not shown in the drawings). The structure is simple and convenient for installation.

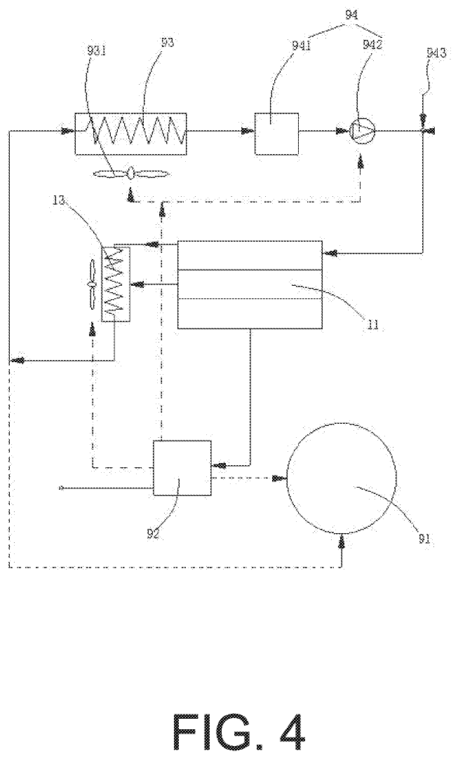

The present disclosure further provides a thermoelectric power generation system, as shown in FIG. 4, the thermoelectric power generation system includes the cogeneration apparatus as well as a control system 91, a power storage apparatus 92, a second heat exchanger 93 and a water supply system 94; the control system 91 is electrically connected to the cogeneration apparatus, the power storage apparatus 92 is configured to store electric energy generated by the cogeneration apparatus and to perform power supply or auxiliary power supply on an electrical appliance, and the power storage apparatus 92 is equipped with an output port 921, and is electrically connected to the cogeneration apparatus, the control system 91, the second heat exchanger 93 and the water supply system 94. The second heat exchanger 93 is connected to the heat exchanger 13, and the water supply system 94 is connected to the second heat exchanger 93 so as to provide a cold source to the cold-end component 3. The power storage apparatus 92 is added in the system, so as to solve the mismatched problem between the power generation and device power consumption. When the power generation is greater than the device power consumption, the excess electricity is delivered to the power storage apparatus 92 for storage, and when the power generation is less than the device power consumption, the power storage apparatus 92 supplies a part of power to the device.

In addition, the water supply system 94 is added in the system, so the system may realize the cold source input of the cold-end component 3 through water circulation, specifically, the water supply system 94 includes an expander 941 and a water pump 942 that are connected to a water outlet pipeline of the cold-end component 3, and in addition, the expander 941 and the water pump 942 are connected to a water inlet end of the cold-end component 3 through a three-way valve. The three-way valve may also be externally connected to a water source inlet 943, and cold water may be supplemented through the water source inlet 943. However, the expander 941 is conductive to controlling the pressure of the water outlet pipeline, and promoting heat dissipation while thermal expansion. In this solution, the power of the water pump 942 may be from the power storage apparatus 92.

In this system, the second heat exchanger 93 is mainly used for cooling the water in the water outlet pipeline of the cold-end component 3, the second heat exchanger 93 may be additionally equipped with a heat exchange fan 931, and the power of the heat exchange fan 931 may be from the power storage apparatus 92.

The present disclosure further provides a voltage control method for a thermoelectric power generation wind turbine, including the following steps of:
Step 1: controlling a voltage value of a wind turbine component to an intimal voltage value U0 and obtaining the current generated power P0 after starting a cogeneration apparatus.
Step 2: controlling the voltage value of the wind turbine component to a first voltage U1, and obtaining first generated power P1, where U1=U0+UP, and UP is unit voltage;
Step 3: controlling the voltage value of the wind turbine component to a second voltage U2 and obtaining second generated power P2, where U1=U0?UP;
Step 4: comparing the current generated power P0 with the first generated power P1 and the second generated power P2;
Step 5:
the cogeneration apparatus keeping the current voltage value for working until the control being end if the current generated power P0 being a maximum value;

If the first generated power P1 being a maximum value in the current generated power P0 and the second generated power P2, adjusting the current generated power P0 to P1, and repeating steps 2-5 until the control being end; and

If the second generated power P2 being a maximum value in the current generated power P0 and the first generated power P1, adjusting the current generated power P0 to P2, and repeating steps 2-5 until the control being end.

In the above control method, the value of the unit voltage UP may be 0.01, 0.1v, 1v or user-defined, so as to obtain the first generated power P1 and the second generated power P2 after rising or declining the first voltage by one unit voltage. The cogeneration apparatus can obtain the best working voltage value after adjusting the voltage value through the above voltage control method, and the working voltage value makes the device the best thermal uniformity and the highest power generation efficiency.

The present disclosure further provides a heating device, including the thermal collector 11, on which a heat collecting member is disposed, and a warm air exporting component is also connected to an outer side of the thermal collector 11. The warm air exporting component may adopt the wind turbine arranged outside the thermal collector 11. After the thermal collector 11 absorbs the heat, the wind turbine exports warm airflow, thereby realizing the heating effect.

The present disclosure provides a cogeneration apparatus, which can collect the heat generated after gas combustion through the thermal collector, the heat is used for heating one end of the thermoelectric power generation component, and the other end can improve the temperature difference at the two ends of the thermoelectric power generation component through the cold source provided by the cold-end component. Through the reasonable structure setting, the cogeneration apparatus can provide the power output after gas combustion. Moreover, in this solution, a gap is left between the upper end of the thermoelectric power generation component and the upper end of the thermal collector, and the relationship between the output power of the thermoelectric power generation component and the compensating distance is obtained through the gap, thereby improving the whole power generation efficiency of the apparatus.

It is understood that the present disclosure adopts terms “first”, “second” and the like for describing various information, these information should not be used for limiting these terms. These terms are merely used for distinguishing the same kind of information. For example, without deviating from the scope of the present disclosure, the first information can be called as the second information, and similarly, the second information can also be called as the first information. In addition, orientation or position relationships indicated by the terms “center, “upper”, “lower”, “left”, “right”, “vertical”, “horizontal”, “inner”, “outer” and the like are based on the orientation or position relationships as shown in the drawings, for ease of describing the present disclosure and simplifying the description only, rather than indicating or implying that the mentioned apparatus or element necessarily has a particular orientation and must be constructed and operated in the particular orientation. Therefore, these terms should not be understood as limitations to the present disclosure.

The description above is only an optimized implementation mode of the present disclosure. It is to be pointed out that those of ordinary skill in the art may further make a plurality of improvements and transformations without departing from the technical principles of the present disclosure and all of these fall within the scope of protection of the present disclosure.

What is claimed is:

1. A cogeneration apparatus, comprising: a thermal collector (11);
a thermoelectric power generation component (2), which is disposed on the thermal collector (11) and an end face at one side contacts with the thermal collector (11), an upper end face of the thermal collector (11) is higher than that of the thermoelectric power generation component (2), and a compensating distance (L) exists between the upper end face of the thermoelectric power generation component (2) and the upper end face of the thermal collector (11).

2. The cogeneration apparatus according to claim 1, wherein the thermoelectric power generation component (2) at least comprises a plurality of first thermoelectric power generation sheets (21) disposed on one side of the thermal collector (11), and the height (H) of the thermal collector (11) meets: H=h+X±20 mm; and
h is the total height after the plurality of first thermoelectric power generation sheets (21) are arranged, and X is the height of a single first thermoelectric power generation sheet (21).

3. The cogeneration apparatus according to claim 1, wherein a thermal collecting chamber is disposed in the thermal collector (11), and a plurality of thermal collecting members located in the thermal collecting chamber are also disposed on the thermal collector (11).

4. The cogeneration apparatus according to claim 1, wherein the compensating distance (L) ranges from 12 mm to 55 mm.

5. The cogeneration apparatus according to claim 1, wherein the compensating distance (L) is 42 mm.

6. The cogeneration apparatus according to claim 1, further comprising a cold-end component (3), which contacts with the end face of the other side of the thermoelectric power generation component (2), and the end faces of the two sides of the thermoelectric power generation component (2) form a temperature difference through a cold source.

7. The cogeneration apparatus according to claim 3, further comprising a heat exchanger (13), which is disposed at an upper end of the thermal collector (11), an exhaust port is disposed on the heat exchanger (13), and a wind turbine component is also disposed in the heat exchanger (13).

8. The cogeneration apparatus according to claim 7, further comprising a combustion chamber (12), the thermal collector (11) comprises a left shell (111) and a right shell (112) that are mutually and detachably connected, the left shell (111) and the right shell (112) are mutually installed to form the thermal collecting chamber, and the combustion chamber (12) is disposed at a lower side of the thermal collector (11) and communicates with the thermal collecting chamber; and
each thermal collecting member comprises a plurality of first rib columns and a plurality of second rib columns, the plurality of first rib columns are disposed in the left shell (111), and the plurality of second rib columns are disposed in the right shell (112).

9. The cogeneration apparatus according to claim 8, wherein two sides of the thermal collector (11) are also equipped with raised installation portions (115), in which temperature boreholes (1151) are drilled, and temperature sensors are disposed on the temperature boreholes (1151).

10. The cogeneration apparatus according to claim 9, further comprising a first splint (41) and a second splint (42), which are connected to the thermal collector (11) through connecting rods.

11. A thermoelectric power generation system, comprising the cogeneration apparatus according to claim 1, a control system (91), a power storage apparatus (92), a second heat exchanger (93), and a water supply system (94);
the control system (91) is electrically connected to the cogeneration apparatus, the power storage apparatus (92) is configured to store electric energy generated by the cogeneration apparatus and to perform power supply or auxiliary power supply on an electrical appliance, and the power storage apparatus (92) is equipped with an output port (921), and is electrically connected to the cogeneration apparatus, the control system (91), the second heat exchanger (93) and the water supply system (94);
the second heat exchanger (93) is connected to the heat exchanger (13); and
the water supply system (94) is connected to the second heat exchanger (93), so as to provide the cold-end component (3) with a cold source.

12. A voltage control method for a thermoelectric power generation wind turbine, comprising the following steps of:
step 1: controlling a voltage value of a wind turbine component to an intimal voltage value U0 and obtaining the current generated power P0 after starting a cogeneration apparatus;
step 2: controlling the voltage value of the wind turbine component to a first voltage U1, and obtaining first generated power P1, wherein U1=U0+UP, and UP is a unit voltage value;
step 3: controlling the voltage value of the wind turbine component to a second voltage U2 and obtaining second generated power P2, wherein U1=U0−UP;
step 4: comparing the current generated power P0 with the first generated power P1 and the second generated power P2; and
step 5:
the cogeneration apparatus keeping the current voltage value for working until the control being end if the current generated power P0 being a maximum value;
if the first generated power P1 being a maximum value in the current generated power P0 and the second generated power P2, adjusting the current generated power P0 to P1, and repeating steps 2-5 until the control being end; and
if the second generated power P2 being a maximum value in the current generated power P0 and the first generated power P1, adjusting the current generated power P0 to P2, and repeating steps 2-5 until the control being end.

13. A heating device, comprising the thermal collector (11) according to claim 1, a heat collecting member is disposed on the thermal collector (11), and a warm air exporting component is also connected to an outer side of the thermal collector (11).
